(19) United States
(12) Patent Application Publication
(10) Pub. No.: US 2024/0329204 A1
(43) Pub. Date: Oct. 3, 2024

(54) DISTANCE MEASURING APPARATUS

(71) Applicant: Mitsubishi Electric Corporation, Tokyo (JP)

(72) Inventors: Shota NAKAHARA, Tokyo (JP); Masayuki OMAKI, Tokyo (JP); Natsuki HONDA, Tokyo (JP)

(73) Assignee: Mitsubishi Electric Corporation, Tokyo (JP)

(21) Appl. No.: 18/574,079

(22) PCT Filed: Jul. 12, 2021
(86) PCT No.: PCT/JP2021/026104

§ 371 Date: Dec. 26, 2023

(51) Int. Cl. G01S 7/481; G01S 17/08

(52) U.S. Cl. CPC G01S 7/4811; G01S 17/08

(57) ABSTRACT

A distance measuring apparatus includes light emitting units to emit rays of outgoing light respectively, a plurality of optical separating units, optical scanning unit to scan the rays of outgoing light, which travel via the plurality of optical separating units from the light emitting units, incident on the optical scanning unit at different angles of incidence from each other, a plurality of light receiving elements to respectively receive rays of return light, which are reflected light from an area irradiated with the scanned rays of outgoing light, that reflect off the optical scanning unit and travel via the plurality of optical separating units, and a base member holding the plurality of light receiving elements and the plurality of optical separating units.

### TECHNICAL FIELD

The present disclosure relates to a distance measuring apparatus.

### BACKGROUND ART

Conventional distance measuring apparatuses are known to calculate the distance to a measurement target on the basis of the time from the time point of emitting light to the time point of receiving the reflected light from the measurement target. Also, since onboard distance measuring apparatuses are used for detecting obstacles in advance, they are required to detect obstacles with a wide-angle field of view. For example, in order to achieve a wide-angle field of view, Patent Reference 1 proposes a beam irradiation apparatus for distance measurement that includes one scanning device for scanning laser light, a plurality of light sources emitting laser light, and plurality of light receiving elements that receive the return light, which is the light reflected off the measurement target. This apparatus is equipped with a light source unit that emits a plurality of laser beams to the scanning device and a plurality of light receiving elements disposed at positions corresponding to the angles of incidence made by the plurality of laser beams, thereby enabling scanning of the laser beams at a scanning angle wider than the scanning angle corresponding to the rotation angle of the scanning device and receiving of the return light.

### PRIOR ART REFERENCE

### Patent Reference

Patent Reference 1: Japanese Unexamined Patent Application Publication No. 2015-125109 (paragraphs 0082 to 0083, FIG. 13)

### SUMMARY OF THE INVENTION

### Problem to be Solved by the Invention

However, the conventional apparatus described above requires the use of a plurality of components to support the plurality of light receiving elements, and thus there is a problem in that mounting the plurality of light receiving elements is not easy.

An object of the present disclosure, which has been made to resolve the above-described problems, is to provide a distance measuring apparatus on which a plurality of light receiving elements can be easily mounted.

### Means of Solving the Problem

A distance measuring apparatus according to the present disclosure includes: light emitting units to emit rays of outgoing light respectively; optical separating units; optical scanning unit to scan the rays of outgoing light incident on the optical scanning unit at different angles of incidence from each other, the rays of outgoing light traveling via the optical separating units from the light emitting units; light receiving elements to receive rays of return light respectively, the rays of return light being rays of reflected light from an area irradiated with the scanned rays of outgoing light, the rays of return light reflecting off the optical scanning unit and traveling via the optical separating units; and a base member holding the light receiving elements and the optical separating units.

### Effects of the Invention

According to the present disclosure, ease of mounting the plurality of light receiving elements can be improved.

### BRIEF DESCRIPTION OF THE DRAWINGS

FIG. 1 is an anterior perspective view schematically showing a distance measuring apparatus according to a first embodiment.

FIG. 2 is a posterior perspective view schematically showing the distance measuring apparatus according to the first embodiment.

FIG. 3 is a cross-sectional view of the distance measuring apparatus along the line III-III in FIG. 1.

FIG. 4 is a cross-sectional view of the distance measuring apparatus along the line IV-IV in FIG. 1.

FIG. 5 is a cross-sectional view of the distance measuring apparatus along the line V-V in FIG. 1.

FIG. 6 is a diagram showing a structure of an optical system of the distance measuring apparatus according to the first embodiment and the optical paths of rays of outgoing light and rays of return light.

FIG. 7 is a diagram showing distance measurement areas corresponding to the scanning ranges of the distance measuring apparatus according to the first embodiment.

FIG. 8 is an anterior perspective view schematically showing a distance measuring apparatus according to a second embodiment.

FIG. 9 is a posterior perspective view schematically showing the distance measuring apparatus according to the second embodiment.

FIG. 10 is a cross-sectional view of the distance measuring apparatus along the line SX-SX in FIG. 8.

FIG. 11 is a diagram showing a structure of an optical system of the distance measuring apparatus according to the second embodiment and the optical paths of outgoing light and return light.

FIG. 12 is a diagram showing a structure of an optical system of the distance measuring apparatus according to the third embodiment and the optical paths of outgoing light and return light.

FIG. 13 is a block diagram schematically showing a configuration of a distance measuring system according to a modification.

### MODE FOR CARRYING OUT THE INVENTION

Distance measuring apparatuses according to embodiments will now be described below with reference to the attached drawings. The following embodiments are merely examples, and the embodiments may be combined as appropriate and each embodiment may be modified as appropriate.

In the drawings, identical or equivalent parts are marked with the same reference sign. Also, the drawings show the coordinate axes of an XYZ orthogonal coordinate system. The Z direction is a direction along the center of distance measurement areas where the measurement targets that the distance measuring apparatus measures exist. The +Z direction is a direction in which the center ray of outgoing light travels (i.e., forward) when the center outgoing light of the three rays of outgoing light emitted from the distance measuring apparatus scans in the center direction of the scanning range. The −Z direction is a direction in which return light that is the reflected light from the measurement target travels (i.e., backward) when the center outgoing light of the three rays of outgoing light emitted from the measurement target scans in the center direction of the scanning range. The Y direction is an up-down direction of the distance measuring apparatus. The +Y direction is an upper direction of the distance measuring apparatus, and the −Y direction is a lower direction of the distance measuring apparatus. The X direction is a horizontal direction of the distance measuring apparatus and is perpendicular to both the Y direction and the Z direction.

### First Embodiment

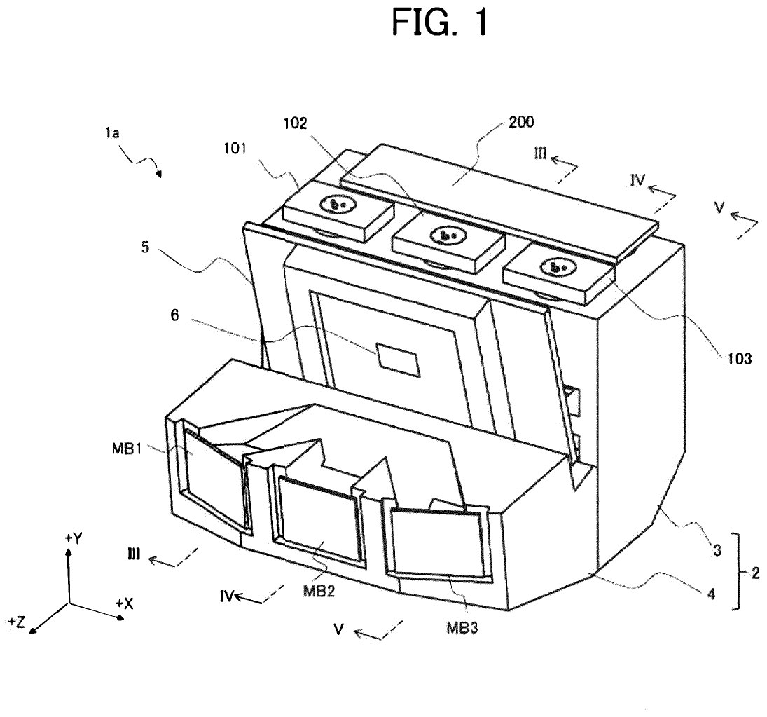

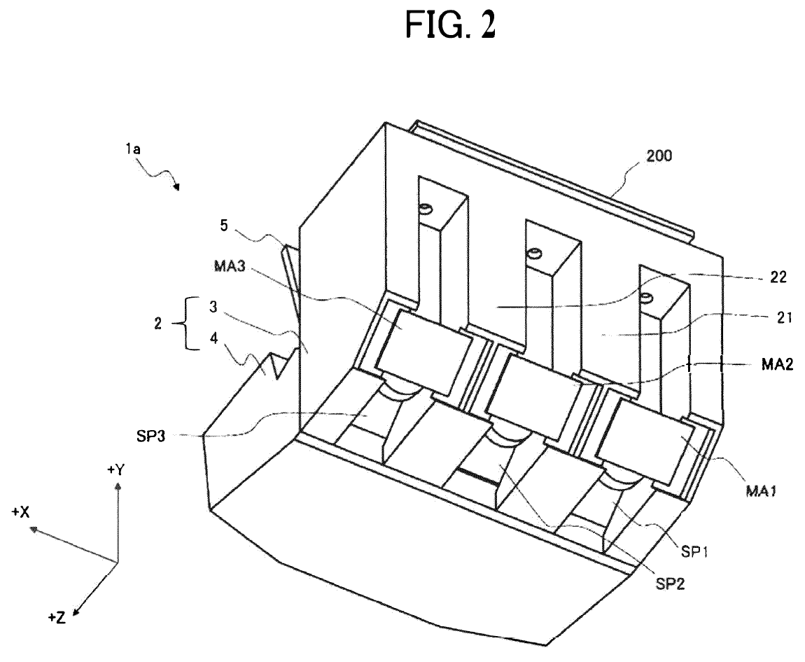

FIG. 1 and FIG. 2 are an anterior perspective view schematically showing a distance measuring apparatus 1a according to a first embodiment and a posterior perspective view schematically showing the distance measuring apparatus 1a according to the first embodiment respectively. As shown in FIG. 1 or FIG. 2, the distance measuring apparatus 1a includes light emitting units 101, 102, 103, which generate rays of outgoing light E1, E2, E3 respectively, a scanning device 5 that is an optical scanning unit, separating mirrors SP1, SP2, SP3 that are optical separating units, a light receiving substrate 200 on which light receiving elements are provided, second deflection mirrors MB1, MB2, MB3 that are second optical deflection members, and a base member 2.

In addition, the distance measuring apparatus 1a includes light receiving units 201, 202, 203, which are described later. Also, the distance measuring apparatus 1a can contain all the components of an optical system in a housing that is open in the +Z direction. In the first embodiment, the description of the housing is omitted. The distance measuring apparatus 1a is installed in the front of a vehicle, for example, to detect a measurement target in front of the vehicle and measure the distance to the measurement target.

The distance measuring apparatus 1a is configured to measure the distance from the measurement target to the distance measuring apparatus 1a by emitting light toward the measurement target (i.e., the measurement target) while scanning the light and receiving the light reflected off the measurement target.

The base member 2 holds and fixes components. The fixed components are the optical system of the distance measuring apparatus 1a (i.e., the optical system of an optical apparatus for measuring distance). For example, the base member 2 secures each component with adhesives, screws, or the like. The base member 2 may be composed of a plurality of components. In the first embodiment, the base member 2 is composed of a rear base portion 3 and a front base portion 4. The base member 2 may be composed of one or more other components.

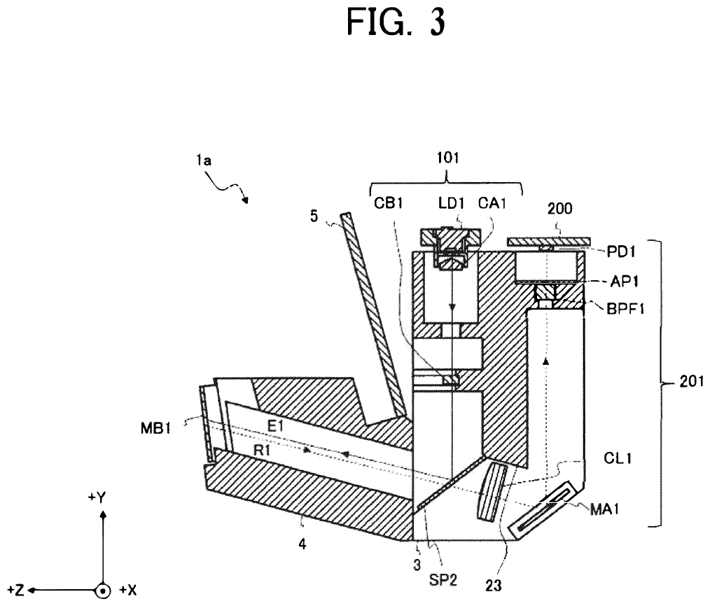

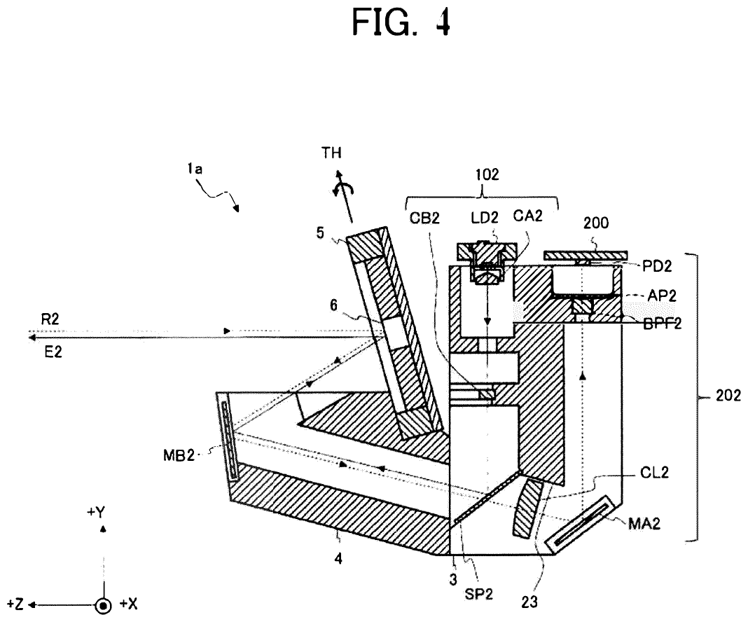

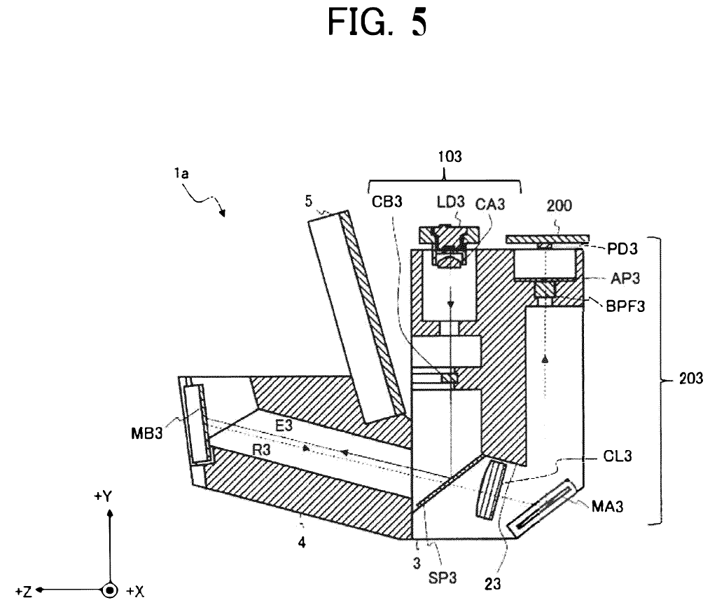

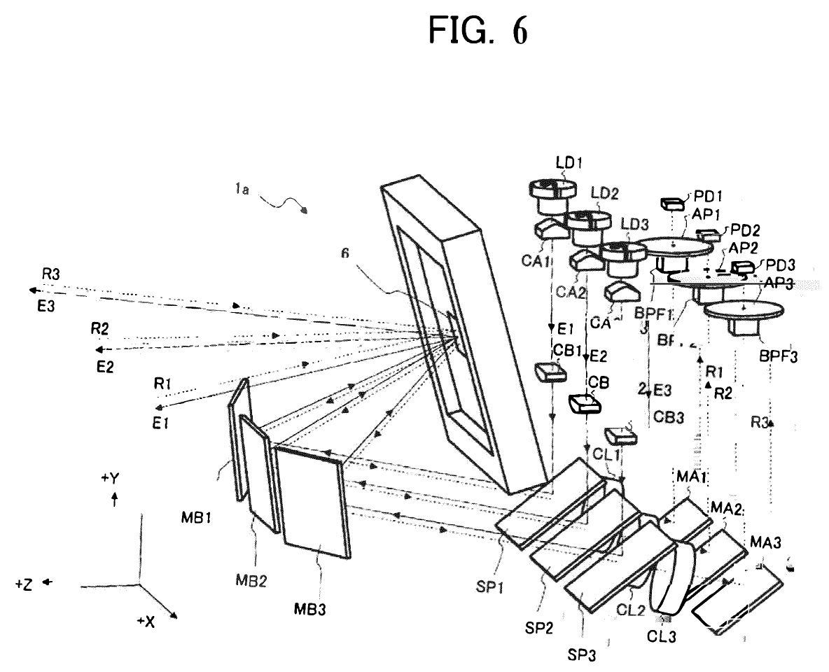

FIG. 3 is a cross-sectional view of the distance measuring apparatus 1a along the line III-III in FIG. 1. FIG. 4 is a cross-sectional view of the distance measuring apparatus 1a along the line IV-IV in FIG. 1. FIG. 5 is a cross-sectional view of the distance measuring apparatus 1a along the line V-V in FIG. 1. FIG. 6 is a diagram showing a structure of an optical system of the distance measuring apparatus 1a according to the first embodiment and the optical paths of rays of outgoing light and rays of return light.

The light emitting units 101, 102, 103 include light sources LD1, LD2, LD3, transmitting optics CA1, CA2, CA3, and transmitting optics CB1, CB2, CB3, respectively. The light emitting units 101, 102, 103 emit outgoing light E1, E2, E3, respectively. In the first embodiment, the light emitting units 101, 102, 103 are aligned in the X direction and fixed to the top surface of the rear base portion 3.

The light emitting unit 102 is disposed at the center of the distance measuring apparatus 1a in the X direction. The light emitting units 101, 103 are disposed in the −Z direction and the +Z direction from the light emitting unit 102 respectively. The distance between the light emitting unit 101 and the light emitting unit 102 is equal to the distance between the light emitting unit 101 and the light emitting unit 103.

The light sources LD1, LD2, LD3 emit light. For example, the light sources LD1, LD2, LD3 are laser light sources, and its outgoing light is laser light. The wavelength of the light generated by each of the light sources LD1, LD2, LD3 is, for example, 870 nm to 1600 nm.

The transmitting optics CA1, CA2, CA3 and the transmitting optics CB1, CB2, CB3 collimate or condense the light generated by the light sources LD1, LD2, LD3, and transmit the outgoing light E1, E2, E3 respectively. Each of the transmitting optics CA1, CA2, CA3 and each of the transmitting optics CB1, CB2, CB3 is composed of, for example, a convex lens, a cylindrical lens, a toroidal lens, or the like. Each of the transmitting optics CA1, CA2, CA3, CB1, CB2, CB3 may be composed of a plurality of optical components such as a plurality of lenses or may be omitted. Also, a part or all of the transmitting optics CA1, CA2, CA3, CB1, CB2, CB3 may be fixed to the base member 2.

In first embodiment, the transmitting optics CA1, CA2, CA3 and the transmitting optics CB1, CB2, CB3 are disposed side by side on a line in the −Y direction passing through the light sources LD1, LD2, LD3 respectively, and transmit the outgoing light E1, E2, E3 in the −Y direction respectively. The transmitting optics CA1, CA2, CA3 are fixed to the light emitting units 101, 102, 103 respectively. The transmitting optics CB1, CB2, CB3 are fixed to the rear base portion 3.

The scanning device 5 reflects the outgoing light E1, E2, E3 emitted from the light emitting units 101, 102, 103 with the scanning mirror 6 to the outside from the inside of the distance measuring apparatus 1a. The scanning device 5 rotates the scanning mirror 6 about the rotation axis TH, which is at least one rotation axis. Also, the scanning device 5 may rotate about other rotation axis (e.g., the rotation axis in the X direction) perpendicular to the rotation axis TH. Also, the scanning device 5 may have both functions of rotating about the rotation axis TH and rotating about other rotation axis perpendicular to the rotation axis TH. In other words, the scanning device 5 may rotate the scanning mirror 6 about two rotation axes that are perpendicular to each other. The scanning device 5 can scan the outgoing light E1, E2, E3 in the horizontal direction by rotating the scanning mirror 6 about the first rotation axis TH. The scanning device 5 can scan the outgoing light E1, E2, E3 in the vertical direction by rotating the scanning mirror 6 about the second rotation axis.

The scanning device 5 is, for example, a Micro Electro Mechanical Systems (MEMS) mirror, a gimbal-type mirror actuator, or the like. The scanning device 5 reflects the outgoing light E2 in the +Z direction in the state where the scanning mirror 6 is in the neutral position of the rotational motion.

In the first embodiment, the scanning device 5 is disposed so that the scanning mirror 6 is at the center position of the distance measuring apparatus 1a in the X direction as shown in FIG. 4, and is fixed to the front base portion 4 in a state tilted about the +X-axis with respect to the Y-X plane (i.e., clockwise about the X-axis when facing in the +X direction), thereby directing the outgoing light E2 reflected off the scanning mirror 6 in the +Z direction in the neutral position of the rotational movement of the scanning mirror 6. The scanning mirror 6 rotates about the rotation axis TH, thereby scanning in the horizontal direction with the outgoing light E2.

The separating mirrors SP1, SP2, SP3 reflect the outgoing light E1, E2, E3 and transmit the return light R1, R2, R3, respectively, that is reflected light reflected off the measurement target. The separating mirrors SP1, SP2, SP3 are, for example, mirrors having a reflective area consisting only of the portion that is irradiated with the outgoing light E1, E2, E3, mirrors having an external shape consisting only of the portion that is irradiated with the outgoing light E1, E2, E3, mirrors that partially transmit and partially reflect the outgoing light E1, E2, E3, or the like.

The separating mirrors SP1, SP2, SP3 are configured to reflect and direct the outgoing light E1, E2, E3 emitted from the light emitting units 101, 102, 103 respectively toward the scanning mirror 6. The outgoing light E1, E2, E3 reflected off the separating mirrors SP1, SP2, SP3 may travel via a plurality of mirrors before reaching the scanning mirror 6, preferably via the second deflection mirrors MB1, MB2, MB3.

The return light R1, R2, R3 transmitted through the separating mirrors SP1, SP2, SP3 are configured to travel to the light receiving units 201, 202, 203.

Accordingly, the light emitting units 101, 102, 103, the scanning device 5, and the light receiving units 201, 202, 203 constitute coaxial optical systems in which the outgoing light E1, E2, E3 and the return light R1, R2, R3 are partially coaxial, respectively. For that reason, ambient light is less likely incident on the light receiving units 201, 202, 203, and thus the S/N ratio of the distance measuring apparatus 1a to ambient light can be improved.

In the first embodiment, the separating mirrors SP1, SP2, SP3 are disposed in the −Y direction from the light emitting units 101, 102, 103 respectively, and are fixed to the rear base portion 3 in a state equally tilted about the −X-axis with respect to the Y-X plane (i.e., clockwise about the X-axis when facing in the −X direction). Accordingly, the separating mirrors SP1, SP2, SP3 deflect the outgoing light E1, E2, E3 in the +Y and −Z direction (i.e., in the direction between the +Y direction and the −Z direction) by a predetermined angle, and direct the outgoing light E1, E2, E3 to the second deflection mirrors MB1, MB2, MB3.

The second deflection mirrors MB1, MB2, MB3 are configured to reflect and direct the outgoing light E1, E2, E3 deflected by the separating mirrors SP1, SP2, SP3 respectively, toward the scanning mirror 6.

In the first embodiment, the second deflection mirrors MB1, MB2, MB3 are disposed in the +Z direction from the scanning mirror 6. The second deflection mirror MB2 is fixed to the front base portion 4 in a state tilted about the +X-axis with respect to the Y-X plane (i.e., clockwise about the X-axis when facing in the +X direction). Accordingly, the second deflection mirror MB2 deflects the outgoing light E2 in the +Y and −Z direction (i.e., in the direction between the +Y direction and the −Z direction) by a predetermined angle, and directs the outgoing light E2 to the scanning mirror 6. The second deflection mirror MB1 is fixed to the front base portion 4 in a state tilted about the +X-axis and the −Y-axis (i.e., clockwise about the X-axis when facing in the +X direction and clockwise about the Y-axis when facing in the −Y direction) with respect to the Y-X plane. Accordingly, the second deflection mirror MB1 deflects the outgoing light E1 in the +Y, −Z, and +X direction (i.e., in the direction among the +Y direction, the −Z direction, and the +X direction) by a predetermined angle, and directs the outgoing light E1 to the scanning mirror 6. The second deflection mirror MB3 is fixed to the front base portion 4 in a state tilted about the +X-axis and the +Y-axis (i.e., clockwise about the X axis when facing in the +X direction and clockwise about the Y axis when facing in the +Y direction) with respect to the Y-X plane. Accordingly, the second deflection mirror MB3 deflects the outgoing light E3 in the +Y, −Z, and −X direction (i.e., in the direction among the +Y direction, the −Z direction, and the −X direction) by a predetermined angle, and directs the outgoing light E3 to the scanning mirror 6.

The light receiving units 201, 202, 203 include light receiving elements PD1, PD2, PD3, aperture units AP1, AP2, AP3 each having an aperture (i.e., an opening) and a light shielding portion in which the opening formed, optical filters BPF1, BPF2, BPF3, first deflection mirrors MA1, MA2, MA3, and light receiving-and-condensing optics CL1, CL2, CL3 respectively. The light receiving elements PD1, PD2, PD3 are mounted on the light receiving substrate 200 as a shared mounting substrate. The light receiving units 201, 202, 203 receive the return light R1, R2, R3 respectively, and output detection signals according to the intensity of the return light R1, R2, R3.

The light receiving elements PD1, PD2, PD3 are configured to detect the return light R1, R2, R3 respectively. The light receiving elements PD1, PD2, PD3 are, for example, photodiodes, avalanche photodiodes, silicon photomultipliers, or the like.

The light receiving substrate 200 is a substrate on which the light receiving elements PD1, PD2, PD3 are mounted. The light receiving substrate 200 monitors and outputs detection signals according to the light detected by the light receiving elements PD1, PD2, PD3.

The light receiving-and-condensing optics CL1, CL2, CL3 are configured to condense the return light R1, R2, R3 respectively. The light receiving-and-condensing optics CL1, CL2, CL3 are, for example, lenses, mirrors, combinations thereof, or the like. For example, the light receiving-and-condensing optics CL1, CL2, CL3 converge the return light R1, R2, R3 respectively, and thus the light receiving elements PD1, PD2, PD3 are irradiated with the converged return light R1, R2, R3 respectively. The light receiving-and-condensing optics CL1, CL2, CL3, for example, converge the return light R1, R2, R3 into the openings, as focuses, of the aperture units AP1, AP2, AP3 respectively.

The aperture units AP1, AP2, AP3 include apertures through which light passes and are configured to determine the light receiving-and-viewing angle of the distance measuring apparatus 1a by blocking a part of the return light R1, R2, R3 incident on the light receiving elements PD1, PD2, PD3. The aperture units AP1, AP2, AP3 may be integrated with the rear base portion 3. Also, the aperture units AP1, AP2, AP3 may be omitted.

The optical filters BPF1, BPF2, BPF3 are disposed to set the wavelength bands of the return light R1, R2, R3 incident on the light receiving elements PD1, PD2, PD3. The optical filters BPF1, BPF2, BPF3 transmit light having the wavelength band of light emitted from the light sources LD1, LD2, LD3 and exclude the other light. The optical filters BPF1, BPF2, BPF3 are, for example, absorption-type filters, dichroic filters, or the like. The optical filters BPF1, BPF2, BPF3 may be omitted.

The first deflection mirrors MA1, MA2, MA3 are configured to reflect the return light R1, R2, R3 in the same direction and direct the reflected return light R1, R2, R3 to the light receiving elements PD1, PD2, PD3 respectively. In other words, the return light R1, R2, R3 traveling to the light receiving elements PD1, PD2, PD3 from the first deflection mirrors MA1, MA2, MA3 are parallel to each other. Accordingly, the orientation of the light receiving surfaces of the light receiving elements PD1, PD2, PD3 can be identical.

In the first embodiment, the light receiving elements PD1, PD2, PD3 are mounted on the surface, which faces in the −Y direction, of the light receiving substrate 200. The light receiving substrate 200 is fixed to the top surface of the rear base portion 3. The light receiving elements PD1, PD2, PD3 are disposed at the same position in the Y direction and are arranged to receive the return light R1, R2, R3 traveling in the +Y direction respectively. The aperture units AP1, AP2, AP3 are fixed to the rear base portion 3 at the positions in the −Y direction from the light receiving elements PD1, PD2, PD3 respectively. The optical filters BPF1, BPF2, BPF3 are fixed to the rear base portion 3 in the same orientation at the positions in the −Y direction from the aperture units AP1, AP2, AP3 respectively. The first deflection mirrors MA1, MA2, MA3 are arranged at the intersections of imaginary straight lines from the light receiving elements PD1, PD2, PD3 to the −Y direction and the return light R1, R2, R3 transmitted through the separating mirrors SP1, SP2, SP3 respectively. These positions are the corner edges (i.e., the edges in the −Y and −Z directions) of portions facing the outside of the rear base portion 3. The first deflection mirrors MA1, MA2, MA3 are fixed to the rear base portion 3 in a state equally tilted about the −X-axis with respect to the Y-X plane (i.e., clockwise about the X-axis when facing in the −X direction). Accordingly, the first deflection mirrors MA1, MA2, MA3 deflect the return light R1, R2, R3 in the +Y direction, and direct the return light R1, R2, R3 to the light receiving elements PD1, PD2, PD3. In addition, the first deflection mirrors MAL, MA2, MA3 are disposed at the same position in the % direction as each other and at the same position in the Y direction as each other, and arranged in line in the X direction. Furthermore, the light receiving-and-condensing optics CL1, CL2, CL3 are disposed between the first deflection mirrors MA1, MA2, MA3 and the separating mirrors SP1, SP2, SP3 respectively, and are fixed to the rear base portion 3.

Also, in order to prevent leakage light of the outgoing light E1, E2, E3 and various disturbance light coming through an opening of the housing of the distance measuring apparatus 1a from unintentionally entering the light receiving elements PD1, PD2, PD3, a partition that does not allow light to pass through between the area including the optical paths of the outgoing light E1, E2, E3 and the area including the optical paths of the return light R1, R2, R3 may be provided. In the first embodiment, the rear base portion 3 includes an inner wall 23, and the inner wall. 23 separates the region of the optical paths of the outgoing light E1, E2, E3 and the region of the optical paths of the return light R1, R2, R3. Also, the rear base portion 3 includes inner walls 21, 22, and the inner walls 21, 22 divide the respective regions of the optical paths of the return light R1, R2, R3.

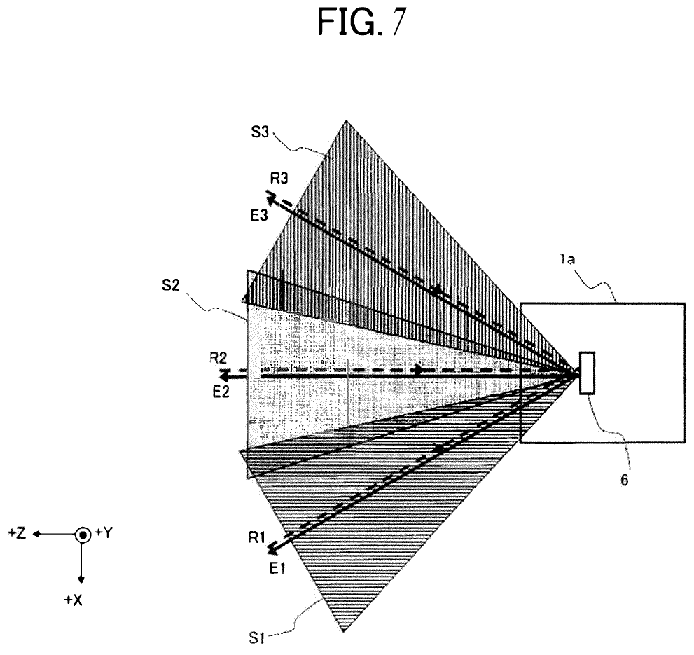

Next, the function of the optical system of the distance measuring apparatus 1a and the optical paths will now be explained with reference to FIG. 6 and FIG. 7. FIG. 6 is a diagram showing the structure of the optical system of the distance measuring apparatus 1a, and the optical paths of the outgoing light E1, E2, E3 and the return light R1, R2, R3. FIG. 7 is a diagram showing the distance measurement areas S1, S2, S3 (i.e., the irradiated areas with the outgoing light) corresponding to the scanning ranges of the distance measuring apparatus 1a. It should be noted that FIG. 6 shows only the main optical components, and other components such as the base member 2 are not shown.

The outgoing light E1 emitted from the light source LD1 in the −Y direction is collimated by the transmitting optic CAL and the transmitting optic CB1, and is incident on the separating mirror SP1. The outgoing light E1 reflected off the separating mirror SP1 travels in the +Y and +Z direction (i.e., in the direction between the +Y direction and the +Z direction), and is incident on the second deflection mirror MB1. The outgoing light E1 reflected off the second deflection mirror MB1 travels in the +Y, −Z, and +X direction (i.e., in the direction among the +Y direction, the −Z direction, and the +X direction), and is incident on the scanning mirror 6. The outgoing light E1 reflected off the scanning mirror 6 travels in the +Z and +X direction (i.e., in the direction between the +Z direction and the +X direction). In other words, the outgoing light E1 travels to the front and left of the distance measuring apparatus 1a. The scanning mirror 6 rotates about the rotation axis TH, and thus the distance measurement area S1, which is scanned in the horizontal direction corresponding to the rotation angle of the scanning mirror 6, is irradiated with the outgoing light E1. The return light R1 from the measurement target in the distance measurement area S1 travels backward along the optical path of the outgoing light E1 and is incident on the separating mirror SP1. The return light R1 transmitted through the separating mirror SP1 is condensed by the light receiving-and-condensing optic CL1 and is incident on the first deflection mirror MAL. The return light R1 reflected off the first deflection mirror MAL travels in the +Y direction and is incident on the optical filter BPF1. The return light R1, from which the optical filter BPF1 removes light having wavelengths other than the wavelength band of the outgoing light emitted from the light source LD1, is incident on the aperture unit AP1. The return light R1, which has a predetermined light receiving-and-viewing angle formed by the aperture unit AP1, is incident on the light receiving element PD1, and the return light R1 is detected.

The outgoing light E2 emitted in the −Y direction from the light source LD2 is collimated by the transmitting optic CA2 and the transmitting optic CB2, and is incident on the separating mirror SP2. The outgoing light E2 reflected off the separating mirror SP2 travels in the +Y and +Z direction (i.e., in the direction between the +Y direction and the +Z direction), and is incident on the second deflection mirror MB2. The outgoing light E2 reflected off the second deflection mirror MB2 travels in the +Y and −Z direction (i.e., in the direction between the +Y direction and the −Z direction), and is incident on the scanning mirror 6. The outgoing light E2 reflected off the scanning mirror 6 travels in the +Z direction. In other words, the outgoing light E2 travels to the straight ahead of the distance measuring apparatus 1a. The scanning mirror 6 rotates about the rotation axis TH, and thus the distance measurement area S2, which is scanned in the horizontal direction corresponding to the rotation angles of the scanning mirror 6, is irradiated with the outgoing light E2. The return light R2 from the measurement target in the distance measurement area S2 travels backward along the optical path of the outgoing light E2 and is incident on the separating mirror SP2. The return light R2 transmitted through the separating mirror SP2 is condensed by the light receiving-and-condensing optic CL2 and is incident on the first deflection mirror MA2. The return light R2 reflected off the first deflection mirror MA2 travels in the +Y direction and is incident on the optical filter BPF2. The return light R2, from which the optical filter BPF2 removes light having wavelengths other than the wavelength band of the outgoing light emitted from the light source LD2, is incident on the aperture unit AP2. The return light R2, which has a predetermined light receiving-and-viewing angle formed by the aperture unit AP2, is incident on the light receiving element PD2, and the return light R2 is detected.

The outgoing light E3 emitted from the light source LD3 in the −Y direction is collimated by the transmitting optic CA3 and the transmitting optic CB3, and is incident on the separating mirror SP3. The outgoing light E3 reflected off the separating mirror SP3 travels in the +Y and +Z direction (i.e., in the direction between the +Y direction and the +Z direction), and is incident on the second deflection mirror MB3. The outgoing light E3 reflected off the second deflection mirror MB3 travels in the +Y, −Z, and −X direction (i.e., in the direction among the +Y direction, the −Z direction, and the −X direction), and is incident on the scanning mirror 6. The outgoing light E3 reflected off the scanning mirror 6 travels in the +Z and −X direction (i.e., in the direction between the +Z direction and the −X direction). In other words, the outgoing light E3 travels to the front and right of the distance measuring apparatus 1a. The scanning mirror 6 rotates about the rotation axis TH, and thus the distance measurement area S3, which is scanned in the horizontal direction corresponding to the rotation angles of the scanning mirror 6, is irradiated with the outgoing light E3. The return light R3 from the measurement target in the distance measurement area S3 travels backward along the optical path of the outgoing light E3 and is incident on the separating mirror SP3. The return light R3 transmitted through the separating mirror SP3 is condensed by the light receiving-and-condensing optic CL3 and is incident on the first deflection mirror MA3. The return light R3 reflected off the first deflection mirror MA3 travels in the +Y direction and is incident on the optical filter BPF3. The return light R3, from which the optical filter BPF3 removes light having wavelengths other than the wavelength band of the outgoing light emitted from the light source LD3, is incident on the aperture unit AP3. The return light R3, which has a predetermined light receiving-and-viewing angle formed by the aperture unit AP3, is incident on the light receiving element PD3, and the return light R3 is detected.

Accordingly, the distance measuring apparatus 1a can measure distances in a wider range of angles than the scanning angles corresponding to the rotation angles of the scanning mirror 6. It should be noted that FIG. 7 shows the distance measurement areas S1, S2, S3 overlapping each other, but the boundaries of adjacent distance measurement areas may coincide with each other, or adjacent distance measurement areas may be separated from each other.

Next, the advantages of the first embodiment will now be explained. With the distance measuring apparatus 1a according to the first embodiment, as shown in FIG. 6, the return light R1, R2, R3 travel in the same direction by the first deflection mirrors MA1, MA2, MA3 respectively, and is incident on the light receiving elements PD1, PD2, PD3. Accordingly, the light receiving elements PD1, PD2, PD3 can be disposed in the same orientation, and thus the ease of mounting the light receiving elements PD1, PD2, PD3 on the light receiving substrate 200 can be improved.

Also, in order to deflect the return light R1, R2, R3 by the first deflection mirrors MA1, MA2, MA3, the first deflection mirrors MA1, MA2, MA3 are located at the corner edges of portions facing the outside of the base member 2. Usually, the adjustment of the optical axis of the light-receiving field of view of distance measuring apparatuses is required. In particular, in a distance measuring apparatus such as the first embodiment, where the optical paths of the outgoing and return light are configured to be the same, it is necessary to adjust the optical axis to match the optical axis of the return light with the optical axis of the outgoing light. When the optical axes for a plurality of light receiving elements mounted on a single light receiving substrate are adjusted, since each of the light receiving elements cannot be moved independently, it is contemplated to adjust the optical axes by holding the lens of the light receiving-and-condensing optic and positioning the lens. The adjustment, however, is difficult because it is necessary to adjust the position of the lens disposed the inside of the optical path of the return light, but no space exists for adjusting the position. On the other hand, in the first embodiment, the optical axes can be adjusted in the same way by adjusting the positions and angles of the first deflection mirrors MA1, MA2, MA3. Since the first deflection mirrors MA1, MA2, MA3 are located at the corner edges of portions facing the outside of the base member 2, it is easy to secure an adjustment workspace and make the adjustment easily. Also, since the general lenses having thin cylindrical shapes and are used for optical purposes except for the side surfaces of the lenses, it is necessary to hold only onto the side surfaces of the lenses, and thus it is difficult to hold and adsorb itself. On the other hand, each of the first deflection mirrors MA1, MA2, MA3 has a flat shape, and the plane opposite the reflection surface does not act optically and consequently holding this surface by adsorption is easy.

Furthermore, as shown in FIG. 6, the light emitting units 101, 102, 103, the scanning device 5, and the light receiving units 201, 202, 203 constitute coaxial optical systems in which the outgoing light E1, E2, E3 and the return light R1, R2, R3 are partially coaxial, respectively. Accordingly, ambient light is less likely incident on the light receiving units 201, 202, 203, and thus the S/N ratio of the distance measuring apparatus 1a to ambient light can be improved.

Furthermore, as shown in FIG. 6, the light receiving elements PD1, PD2, PD3 are disposed in the same orientation and at the same position in the Y direction. Accordingly, three or more light receiving elements can be provided, and thus the distance measuring can be performed in a wider range of angles. In addition, in the distance measuring apparatus, the light receiving elements are not only arranged in a line but also distributed on a plane, thereby facilitating its optical design.

Furthermore, as shown in FIG. 1, all light receiving elements are mounted on one light receiving substrate 200. Accordingly, the substrate manufacturing cost can be made inexpensive.

Furthermore, as shown in FIG. 6, the optical filters BPF1, BPF2, BPF3 are disposed in the −Y direction of the light receiving elements PD1, PD2, PD3 respectively in the state where the surfaces on which the return light R1, R2, R3 is incident face in the same orientation. Accordingly, the return light R1, R2, R3 is incident at the same angle on the optical filters BPF1, BPF2, BPF3 respectively. Therefore, the effects due to the dependence of incidence angles to the optical filters can be eliminated, and the optical filters BPF1, BPF2, BPF3 can be formed in a shared component. Such a structure is particularly suitable for distance measuring apparatuses that include dichroic optical filters having the dependence of incidence angle according to selected wavelength.

Furthermore, as shown in FIG. 6, the aperture units AP1, AP2, AP3 are disposed at the positions, which are located just in front of the light receiving elements PD1, PD2, PD3, on the optical paths of the return light R1, R2, R3 traveling toward the light receiving elements PD1, PD2, PD3. Accordingly, the light receiving-and-viewing angles of the light receiving elements PD1, PD2, PD3 are limited, and thus the resolving power of the light receiving elements PD1, PD2, PD3 can be enhanced. Let be f the focal length of the light receiving-and-condensing optic and be D the aperture diameter (i.e., the diameter of the opening), the light receiving-and-viewing angle θ is expressed as follows: θ=arctan (D/f). Therefore, by setting the aperture diameter D appropriately, the light receiving-and-viewing angle θ becomes the desired value regardless of the size of the light receiving element.

Furthermore, as shown in FIG. 6, the return light R1, R2, R3 condensed by the light receiving-and-condensing optics CL1, CL2, CL3 is incident on the first deflection mirrors MA1, MA2, MA3. Accordingly, the irradiated areas with the return light R1, R2, R3 are made small, and the reflective surfaces of the first deflection mirrors MA1, MA2, MA3 can be made small, and thus the first deflection mirrors MA1, MA2, MA3 can be downsized.

Also, the focal lengths of the light receiving-and-condensing optics CL1, CL2, CL3 can be extended because the distances from the light receiving-and-condensing optics CL1, CL2, CL3 to the aperture units AP1, AP2, AP3 are longer than the case where the return light R1, R2, R3 is incident on the light receiving-and-condensing optics CL1, CL2, CL3 after being deflected by the first deflection mirrors MA1, MA2, MA3. Let be f the focal length of the light receiving-and-condensing optic and be D the aperture diameter, the light receiving-and-viewing angle θ is expressed as follows:

θ=arctan(D/f).

For the same light receiving-and-viewing angle θ, the longer the focal length f is, the larger the aperture diameter D becomes. Therefore, the accuracy of machining the openings of the aperture units with respect to the light receiving-and-viewing angle θ can be relaxed, and the machining cost of the aperture units AP1, AP2, AP can be reduced.

For example, in the case where the light receiving-and-viewing angle θ is 0.50 degrees in optical design, when the focal length f of the light receiving-and-condensing optic is short, f=20 mm, the aperture diameter D is 0.1746 mm. In this case, when a processing error of +0.01 mm occurs in the aperture diameter D, the light receiving-and-viewing angle θ becomes 0.529 degrees. On the other hand, when the focal length f of the light receiving-and-condensing optic is increased, f=40 mm, the aperture diameter D becomes 0.3491 mm. In this case, similarly when a processing error of +0.01 mm occurs in the aperture diameter D, the light-receiving-and-viewing angle @ becomes 0.514 degrees, indicating that the processing error of the aperture diameter D has little effect on the light-receiving-and-viewing angle.

Also, similarly, the effect on the error in the fixing position in the in-plane direction of the aperture units AP1, AP2, AP3 (i.e., the error in the fixing position on the plane including the aperture units AP1, AP2, AP3) to the base member 2 is also relaxed, and thus the accuracy of assembling the base member 2 can be relaxed. Also, by extending the focal length f and configuring the aperture diameter D with respect to the light receiving-and-viewing angle θ to be equal to the size of the light receiving element, the aperture units AP1, AP2, AP3 can be omitted. Also, by lengthening the focal length f of the light receiving-and-condensing optics CL1, CL2, CL3, the angle of light condensing at the focal position becomes acute angle, thereby mitigating the effect on light receiving performance due to the misalignment of the aperture units AP1, AP2, AP3 in a focus direction relative to the light receiving-and-condensing optics CL1, CL2, CL3. Also, in the configuration where the aperture units are eliminated, the effect on light receiving performance due to the misalignment of the light receiving elements PD1, PD2, PD3 in the focus direction can be mitigated.

Furthermore, as shown in FIG. 6, the light receiving-and-condensing optics CL1, CL2, CL3 are disposed between the first deflection mirrors MA1, MA2, MA3 and the separating mirrors SP1, SP2, SP3. Accordingly, the light emitting units 101, 102, 103 can emit the outgoing light E1, E2, E3 without optical action due to the light receiving-and-condensing optics CL1, CL2, CL3, thereby improving the optical performance of the outgoing light E1, E2, E3.

Furthermore, as shown in FIG. 6, the first deflection mirrors MA1, MA2, MA3 are disposed in the same position in the Z direction as each other, in the same position in the Y direction as each other, and in line in the X direction. Accordingly, in the operation of adjusting the optical axis with the first deflection mirrors MA1, MA2, MA3, by simply moving the adjustment device that holds the first deflection mirrors MA1, MA2, MA3 in the horizontal direction or simply moving the distance measuring apparatus 1a in the horizontal direction, it is possible to hold each of the first deflection mirrors MA1, MA2, MA3, and thus the adjustment is facilitated.

Furthermore, as shown in FIG. 6, the light receiving elements PD1, PD2, PD3 are disposed so as to receive the return light R1, R2, R3 traveling, via the first deflection mirrors MA1, MA2, MA3, in the direction opposite to the direction in which the outgoing light E1, E2, E3 are emitted from the light emitting units 101, 102, 103. Accordingly, the light receiving units 201, 202, 203 can be disposed in the same direction as the light emitting units 101, 102, 103, and the dimensions along the Z and Y directions of the distance measuring apparatus 1a can be smaller than the case where the light receiving units 201, 202, 203 are disposed in other directions.

Furthermore, as shown in FIG. 6, the outgoing light E1, E2, E3 reflected off the separating mirrors SP1, SP2, SP3 are directed from the light emitting units 101, 102, 103 disposed in the −Z direction of the scanning mirror 6 to the second deflection mirrors MB1, MB2, MB3 disposed in the state protruding in the +Z direction from the scanning mirror 6, and the outgoing light E1, E2, E3 is directed to the scanning mirror 6 by the second deflection mirrors MB1, MB2, MB3. As described above, the light emitting units 101, 102, 103 and the light receiving units 201, 202, 203 are disposed together in the −Z direction from the scanning mirror 6. Accordingly, the dimension in the Z direction of the portion protruding in the +Z direction from the scanning mirror 6 is reduced. Therefore, as shown in FIG. 7, the dimensions along the X direction of the distance measuring apparatus 1a can be reduced because it is no longer necessary to provide a space inside the distance measuring apparatus 1a to secure the optical path length of the outgoing light E1, E2, E3, which spreads in the X direction as the outgoing light E1, E2, E3 travels from the scanning mirror 6 to the +Z direction.

Furthermore, as shown in FIG. 6, the optical paths leading from the second deflection mirrors MB1, MB2, MB3 to the light receiving elements PD1, PD2, PD3 respectively are parallel to the Y-Z plane. Accordingly, the first deflection mirrors MA1, MA2, MA3 all have the same inclination, the angles in the case of holding the first deflection mirrors MA1, MA2, MA3 in the operation of adjusting the optical axes and starting the adjustment can be conformed to the same angle, and thus the adjustment is facilitated.

### Second Embodiment

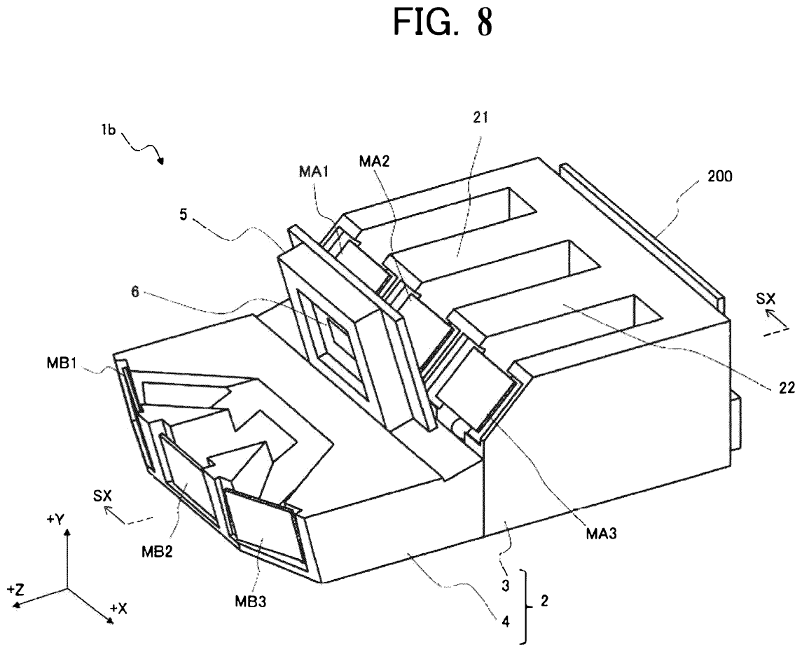

A distance measuring apparatus 1b according to the second embodiment will now be described with reference to FIG. 8 to FIG. 11. The configuration of the distance measuring apparatus 1b according to the second embodiment is the same as the configuration of the distance measuring apparatus 1a according to the first embodiment described above, unless otherwise explained. Thus, each component having the same function as in the first embodiment is assigned the same reference sign, and the explanation is not repeated.

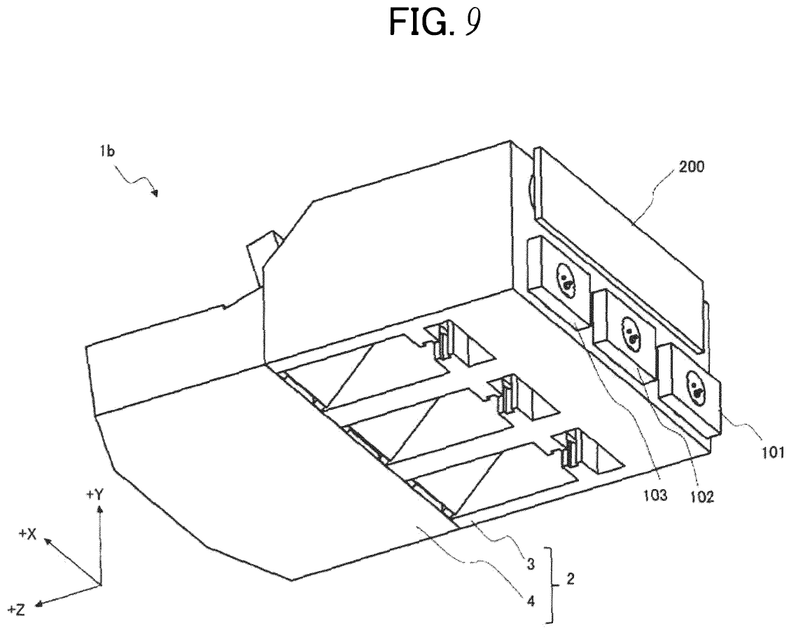

FIG. 8 and FIG. 9 are an anterior perspective view and a posterior perspective view, respectively, schematically showing the distance measuring apparatus 1b according to the second embodiment. As shown in FIG. 8 or FIG. 9, the distance measuring apparatus 1b according to the second embodiment includes the scanning device 5 with smaller dimensions along the Y direction than the distance measuring apparatus 1a according to the first embodiment. In the scanning device 5, when the light emitting units 101, 102, 103 are disposed in the +Y direction so that the outgoing light E1, E2, E3 are emitted in the −Y direction, only the light emitting units 101, 102, 103 protrude in the +Y direction. In particular, if a distance measuring apparatus with a small dimension in the Y direction is required under the condition of installation space, there is a problem in that the distance measuring apparatus cannot be installed. For that reason, the distance measuring apparatus 1b according to the second embodiment is configured so that the dimensions along the Y direction are small.

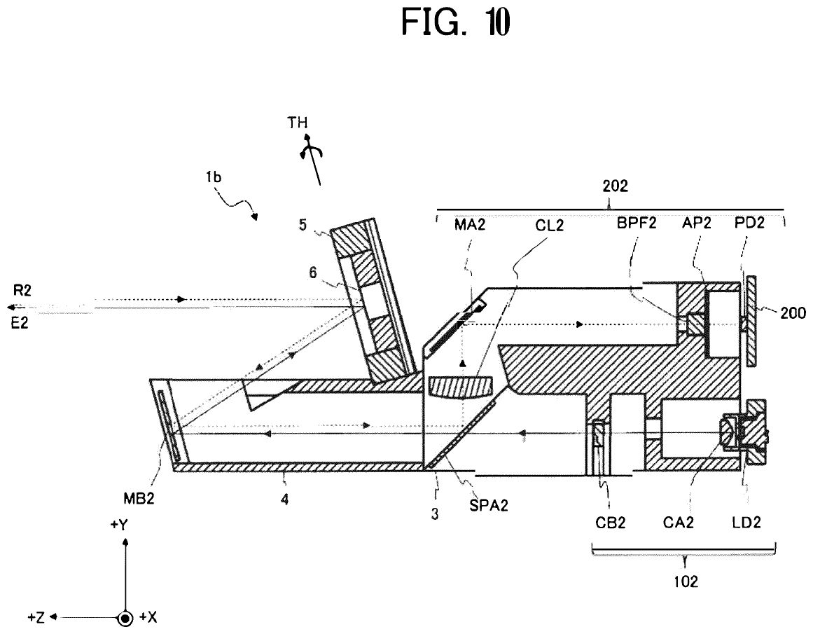

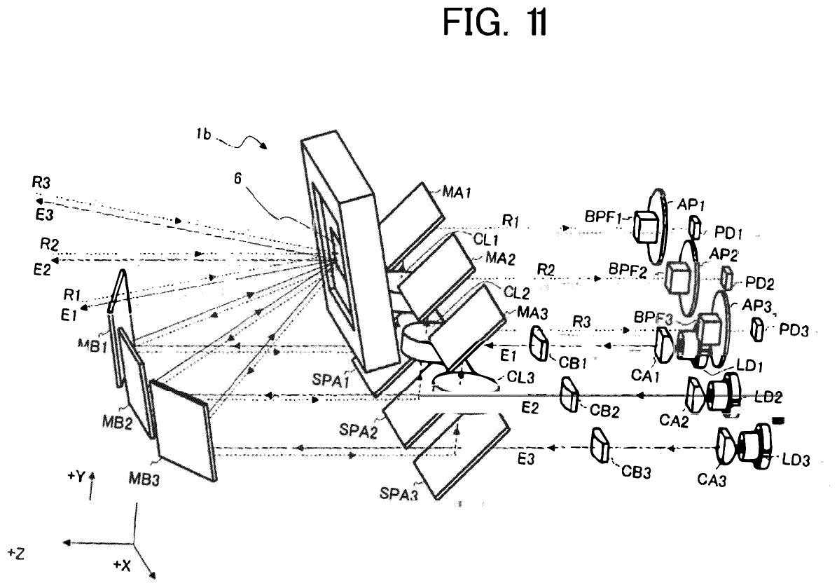

FIG. 10 is a cross-sectional view of the distance measuring apparatus 1b along the line SX-SX in FIG. 8. FIG. 11 is a diagram showing a structure of an optical system of the distance measuring apparatus 1b according to the second embodiment and the optical paths of the outgoing light E1, E2, E3 and the return light R1, R2, R3.

The distance measuring apparatus 1b according to the second embodiment includes separating mirrors SPA1, SPA2, SPA3. The separating mirrors SPA1, SPA2, SPA3 transmit (i.e., pass through) the outgoing light E1, E2, E3 respectively, and reflect the return light R1, R2, R3. In other words, reflected light and transmitted light at the separating mirrors SPA1, SPA2, SPA3 in the second embodiment are reversed in contrast to the first embodiment. The separating mirrors SPA1, SPA2, SPA3 are, for example, mirrors with holes only in the area where the outgoing light E1, E2, E3 is incident, mirrors with no deposited reflective surface only in the area where the outgoing light E1, E2, E3 is incident, or mirrors that partially transmit and partially reflect the return light R1, R2, R3.

The separating mirrors SPA1, SPA2, SPA3 are configured to reflect the return light R1, R2, R3 and direct the return light R1, R2, R3 to the light receiving units 201, 202, 203 respectively.

In the second embodiment, the light emitting units 101, 102, 103 are fixed in a line to the rear of the rear base portion 3. The light emitting unit 102 is disposed at the center of the distance measuring apparatus 1b in the X direction. The light emitting units 101, 103 are disposed in the −Z and +Z directions from the light emitting unit 102 respectively. The distance between the light emitting unit 101 and the light emitting unit 102 is equal to the distance between the light emitting unit 101 and the light emitting unit 103.

The transmitting optics CA1, CA2, CA3 and the transmitting optics CB1, CB2, CB3 are arranged in a straight line in the +Z direction extending from the light sources LD1, LD2, LD3 respectively, and transmit the outgoing light E1, E2, E3 in the +Z direction.

The separating mirrors SPA1, SPA2, SPA3 are disposed in the +Z direction from the light emitting units 101, 102, 103 respectively, and are fixed to the rear base portion 3 in a state equally tilted about the −X-axis with respect to the Y-X plane (i.e., clockwise about the X-axis when facing in the −X direction). Accordingly, the separating mirrors SPA1, SPA2, SPA3 deflect the return light R1, R2, R3 in the +Y direction, and direct the return light R1, R2, R3 to the light receiving units 201, 202, 203 respectively.

The light receiving substrate 200 is fixed to the rear of the rear base portion 3. The light receiving elements PD1, PD2, PD3 are mounted on the surface facing the +Z direction of the light receiving substrate 200. Aperture units AP1, AP2, AP3 are fixed to the rear base portion 3 in the +Z direction from the light receiving elements PD1, PD2, PD3 respectively. The optical filters BPF1, BPF2, BPF3 are fixed to the rear base portion 3 in the +Z direction from the aperture units AP1, AP2, AP3 respectively. The first deflection mirrors MA1, MA2, MA3 are disposed at the intersections of imaginary straight lines extending in the +Z direction from the optical filters BPF1, BPF2, BPF3 and the return light R1, R2, R3 reflected off the separating mirrors SPA1, SPA2, SPA3 respectively. The intersections are the corner edges (i.e., the edges in the +Y and +Z directions) of the portions facing the outside of the rear base portion 3. The first deflection mirrors MA1, MA2, MA3 are fixed to the rear base portion 3 in a state equally tilted about the −X-axis with respect to the Y-X plane (i.e., clockwise about the X-axis when facing in the −X direction). Accordingly, the first deflection mirrors MA1, MA2, MA3 deflect the return light R1, R2, R3 in the −Z direction, and direct the return light R1, R2, R3 to the light receiving elements PD1, PD2, PD3 respectively. The light receiving-and-condensing optics CL1, CL2, CL3 are disposed between the first deflection mirrors MA1, MA2, MA3 and the separating mirrors SPA1, SPA2, SPA3 respectively, and are fixed to the rear base portion 3.

Next, the function of the optical system or the optical paths of the distance measuring apparatus 1b according to the second embodiment will now be described with reference to FIG. 11. In FIG. 11, only the main optical components are shown, and the base member 2 and other components are not shown. The scanning range of the distance measuring apparatus 1b is the same as that shown in FIG. 7.

The outgoing light E1 emitted in the +Z direction from the light source LD1 is collimated by the transmitting optic CAL and the transmitting optic CB1, and is incident on the separating mirror SPA1. The outgoing light E1 transmitted through the separating mirror SPA1 is incident on the second deflection mirror MB1. The outgoing light E1 reflected off the second deflection mirror MB1 travels in the +Y, −Z, and +X direction (i.e., in the direction among the +Y direction, the −Z direction, and the +X direction) and is incident on the scanning mirror 6. The outgoing light E1 reflected off the scanning mirror 6 travels in the + % and +X direction (i.e., in the direction between the +Z direction and the +X direction). In other words, the outgoing light E1 travels to the front and left of the distance measuring apparatus 1b. The scanning mirror 6 rotates about the rotation axis TH, and thus the distance measurement area S1, which is scanned in the horizontal direction corresponding to the rotation angles of the scanning mirror 6, is irradiated with the outgoing light E1. The return light R1 from the measurement target in the distance measurement area S1 travels backward along the optical path of the outgoing light E1 and is incident on the separating mirror SPA1. The return light R1 reflected off the separating mirror SPA1 travels in the +Y direction and is condensed by the light receiving-and-condensing optic CL1 and is incident on the first deflection mirror MA1. The return light R1 reflected off the first deflection mirror MA1 travels in the −Z direction and is incident on the optical filter BPF1. The return light R1, from which the optical filter BPF1 removes light having wavelengths other than the wavelength band of the outgoing light emitted from the light source LD1, is incident on the aperture unit AP1. The return light R1, which has a predetermined light receiving-and-viewing angle formed by the aperture unit AP1, is incident on the light receiving element PD1, and the return light R1 is detected.

The outgoing light E2 emitted in the +Z direction from the light source LD2 is collimated by the transmitting optic CA2 and the transmitting optic CB2, and is incident on the separating mirror SPA2. The outgoing light E2 transmitted through the separating mirror SPA2 is incident on the second deflection mirror MB2. The outgoing light E2 reflected off the second deflection mirror MB2 travels in the +Y and −Z direction (i.e., in the direction between the +Y direction and the −Z direction), and is incident on the scanning mirror 6. The outgoing light E2 reflected off the scanning mirror 6 travels in the +Z direction. In other words, the outgoing light E2 travels to the center-forward of the distance measuring apparatus 1b. The scanning mirror 6 rotates about the rotation axis TH, and thus the distance measurement area S2, which is scanned in the horizontal direction corresponding to the rotation angles of the scanning mirror 6, is irradiated with the outgoing light E2. The return light R2 from the measurement target in the distance measurement area S2 travels backward along the optical path of the outgoing light E2 and is incident on the separating mirror SPA2. The return light R2 reflected off the separating mirror SPA2 travels in the +Y direction and is condensed by the light receiving-and-condensing optic CL2 and is incident on the first deflection mirror MA2. The return light R2 reflected off the first deflection mirror MA2 travels in the −Z direction and is incident on the optical filter BPF2. The return light R2, from which the optical filter BPF2 removes light having wavelengths other than the wavelength band of the outgoing light emitted from the light source LD2, is incident on the aperture unit AP2. The return light R2, which has a predetermined light receiving-and-viewing angle formed by the aperture unit AP2, is incident on the light receiving element PD2, and the return light R2 is detected.

The outgoing light E3 emitted in the +Z direction from the light source LD3 is collimated by the transmitting optic CA3 and the transmitting optic CB3, and is incident on the separating mirror SPA3. The outgoing light E3 transmitted through the separating mirror SPA3 is incident on the second deflection mirror MB3. The outgoing light E3 reflected off the second deflection mirror MB3 travels in the +Y, −Z, and −X direction (i.e., in the direction among the +Y direction, the −Z direction, and the −X direction) and is incident on the scanning mirror 6. The outgoing light E3 reflected off the scanning mirror 6 travels in the +Z and −X direction (i.e., in the direction between the +Z direction and −X direction). In other words, the outgoing light E3 travels to the right-forward of the distance measuring apparatus 1b. The scanning mirror 6 rotates about the rotation axis TH, and thus the distance measurement area S3, which is scanned in the horizontal direction corresponding to the rotation angles of the scanning mirror 6, is irradiated with the outgoing light E3. The return light R3 from the measurement target in the distance measurement area S3 travels backward along the optical path of the outgoing light E3 and is incident on the separating mirror SPA3. The return light R3 reflected off the separating mirror SP3 travels in the +Y direction and is condensed by the light receiving-and-condensing optic CL3 and is incident on the first deflection mirror MA3. The return light R3 reflected off the first deflection mirror MA3 travels in the −Z direction and is incident on the optical filter BPF3. The return light R3, from which the optical filter BPF3 removes light having wavelengths other than the wavelength band of the outgoing light emitted from the light source LD3, is incident on the aperture unit AP3. The return light R3, which has a predetermined light receiving-and-viewing angle formed by the aperture unit AP3, is incident on the light receiving element PD3, and the return light R3 is detected.

Accordingly, the distance measuring apparatus 1b can measure distances in a wider range of angles than the scanning angles corresponding to the rotation angles of the scanning mirror 6.

Next, the advantages of the second embodiment will now be explained. With the distance measuring apparatus 1b according to the second embodiment, the light receiving elements PD1, PD2, PD3 are disposed so as to receive the return light R1, R2, R3 traveling, via the first deflection mirrors MA1, MA2, MA3, in the direction opposite to the direction in which the outgoing light E1, E2, E3 are emitted from the light emitting units 101, 102, 103. Accordingly, the light receiving units 201, 202, 203 can be disposed in the same direction as the light emitting units 101, 102, 103, and the dimensions along the Y direction of the distance measuring apparatus 1b can be smaller than the case where the light receiving units 201, 202, 203 are disposed in other directions.

### Third Embodiment

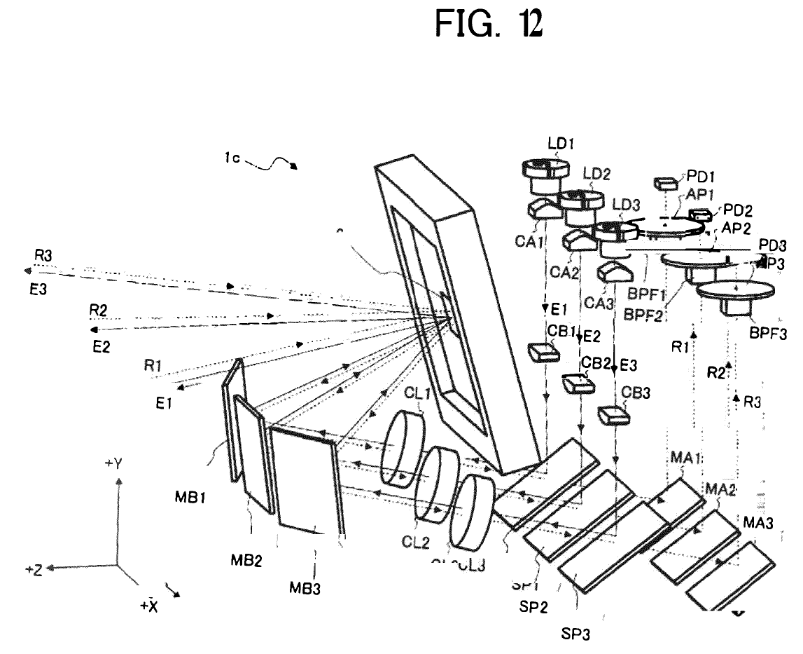

A distance measuring apparatus 1c according to the third embodiment will now be described with reference to FIG. 12. The third embodiment has the same configurations and advantages as the first embodiment described above, unless otherwise explained. The configuration of the distance measuring apparatus 1c according to the third embodiment is the same as the configuration of the distance measuring apparatus 1a according to the first embodiment, unless otherwise explained. Thus, each component having the same function as in the first embodiment is assigned the same reference sign, and the explanation is not repeated.

FIG. 12 is a diagram showing a structure of an optical system of the distance measuring apparatus 1c according to the third embodiment and the optical paths of the outgoing light E1, E2, E3 and return light R1, R2, R3. As shown in FIG. 12, the distance measuring apparatus 1c according to the third embodiment differs from the distance measuring apparatus 1a according to the first embodiment in the disposition of the light receiving-and-condensing optics CL1, CL2, CL3. In the first embodiment, the light receiving-and-condensing optics CL1, CL2, CL3 are disposed between the separating mirrors SP1, SP2, SP3 and the first deflection mirrors MA1, MA2, MA3. On the other hand, in the third embodiment, in order to increase the distances from the light receiving-and-condensing optics CL1, CL2, CL3 to the aperture units AP1, AP2, AP3, the light receiving-and-condensing optics CL1, CL2, CL3 are disposed, in the +Z direction from the separating mirrors SP1, SP2, SP3, between the separating mirrors SP1, SP2, SP3 and the second deflection mirrors MB1, MB2, MB3.

In the third embodiment, the outgoing light E1, E2, E3 is incident on the light receiving-and-condensing optics CL1, CL2, CL3 and travels toward the distance measurement areas that are the irradiated areas with the outgoing light. For that reason, the transmitting optics CA1, CA2, CA3 and the transmitting optics CB1, CB2, CB3, together with the optical action of the light receiving-and-condensing optics CL1, CL2, CL3, are configured to collimate or condense the outgoing light E1, E2, E3.

Next, the advantages of the third embodiment will now be described. With the distance measuring apparatus 1c according the third embodiment, since the light receiving-and-condensing optics CL1, CL2, CL3 are disposed in the +Z direction from the separating mirrors SP1, SP2, SP3, the focal lengths of the light receiving-and-condensing optics CL1, CL2, CL3 can be extended. Accordingly, the effect on light receiving performance due to the accuracy of machining the openings of the aperture units AP1, AP2, AP3, the accuracy of fixing the position of the aperture units AP1, AP2, AP3 in the in-plane direction (i.e., the accuracy of the fixing position on the plane including the aperture units AP1, AP2, AP3), and the accuracy of the misalignment in the focus direction can be mitigated.

Also, in the configuration where the aperture units are eliminated, the effect on light receiving performance due to the misalignment of the light receiving elements PD1, PD2, PD3 in the focus direction can be mitigated.

### Modification

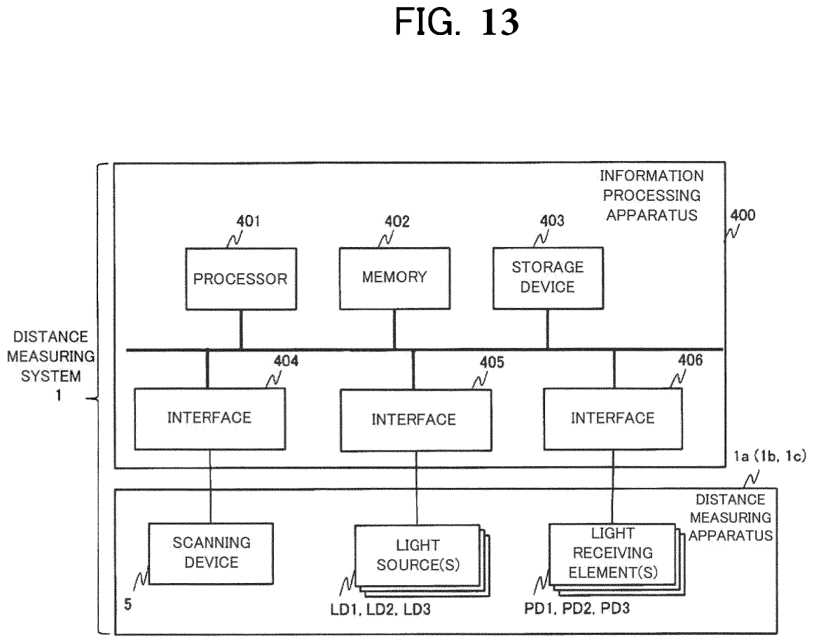

FIG. 13 is a block diagram schematically showing a configuration of a distance measuring system 1 including an information processing apparatus 400 and the distance measuring apparatus 1a (or 1b or 1c) according to a modification. The information processing apparatus 400 is, for example, a processing circuit. Also, the processing circuit may be a computer.

The information processing apparatus 400 is an information processing unit that controls the driving of the scanning device 5 and the driving of the light sources LD1, LD2, LD3, and calculates the distance from the distance measuring apparatus 1a (or 1b or 1c) to the measurement target in the measurement area on the basis of the detection signals of the light receiving elements PD1, PD2, PD3. Specifically, the information processing apparatus 400 calculates the distance from the distance measuring apparatus 1a (or 1b or 1c) to the measurement target on the basis of the time from the time when the light sources LD1, LD2, LD3 emit light to the time when the light receiving elements PD1, PD2, PD3 receive the return light.

The information processing apparatus 400 includes a processor 401, a memory 402, a storage device 403, an interface 404 to be connected to the scanning device 5, an interface 405 to be connected to the light sources LD1, LD2, LD3, and an interface 406 to be connected to the light receiving elements PD1, PD2, PD3. The processor 401 is composed of, for example, a central processing unit (CPU), a graphics processing unit (GPU), a field-programmable gate array (FPGA) or the like. The memory 402 is a volatile storage device such as a random access memory (RAM). The storage device 403 is, for example, a non-volatile storage device such as a hard disk drive (HDD) or a solid state drive (SSD).

The processing circuitry consisting the information processing apparatus 400 may be dedicated hardware or the processor 401 that executes a program, which is stored in the memory 402, for distance measurement. The processor 401 may be a processing unit, an arithmetic unit, a microprocessor, a microcomputer, or a digital signal processor (DSP).

If the processing circuit is a dedicated hardware, the processing circuit may be, for example, a single circuit, a complex circuit, a programmed processor, an application specific integrated circuit (ASIC), a field-programmable gate array (FPGA), or a combination of any of these.

Use of the distance measuring system 1 can measure the distance to a measurement target in a large measurement area.

It should be noted that even when terms such as “parallel,” “perpendicular,” or “center” are used in each embodiment described above to indicate the positional relationship between components or the shape of the components, these terms include the extent to which manufacturing tolerances and assembly variations are considered.

Also, the embodiments and the modifications described above are only examples, and the scope of the present disclosure includes all modifications within the scope indicated by the claims.

### DESCRIPTION OF REFERENCE CHARACTERS

1 distance measuring system, 1a, 1b, 1c distance measuring apparatus, 101, 102, 103 light emitting unit, 200 light receiving substrate, 201, 202, 203 light receiving unit, 2 base member, 3 front base portion, 4 rear base portion, 5 scanning device, 6 scanning mirror (optical scanning unit), TH mirror rotation direction, LD1, LD2, LD3 light source, MA1, MA2, MA3 first deflection mirror, MB1, MB2, MB3 second deflection mirror, CA1, CA2, CA3 transmitting optic, CB1, CB2, CB3 transmitting optic, SP1, SP2, SP3 separating mirror (optical separating unit), SPA1, SPA2, SPA3 separating mirror (optical separating unit), CL1, CL2, CL3 light receiving-and-condensing optic, BPF1, BPF2, BPF3 optical filter, AP1, AP2, AP3 aperture unit, PD1, PD2, PD3 light receiving element, E1, E2, E3 outgoing light, R1, R2, R3 return light, S1, S2, S3 scanning range.

1. A distance measuring apparatus comprising:
light emitting units to emit rays of outgoing light respectively:
optical separating units:
optical scanning unit to scan the rays of outgoing light incident on the optical scanning unit at different angles of incidence from each other, the rays of outgoing light traveling via the optical separating units from the light emitting units:
light receiving elements to receive rays of return light respectively, the rays of return light being rays of reflected light from an area irradiated with the scanned rays of outgoing light, the rays of return light reflecting off the optical scanning unit and traveling via the optical separating units:
a base member holding the light receiving elements and the optical separating units; and
a shared light receiving substrate on which the light receiving elements are provided.

2. (canceled)

3. The distance measuring apparatus according to claim 1, wherein the optical separating units reflect the rays of outgoing light and transmit the rays of return light.

4. The distance measuring apparatus according to claim 3 further comprising first deflection members to direct the rays of return light, which travel via the of optical separating units, to the light receiving elements respectively.

5. The distance measuring apparatus according to claim 1, wherein the optical separating units transmit the rays of outgoing light and reflect the rays of return light.

6. The distance measuring apparatus according to claim 5 further comprising first deflection members to direct the rays of return light reflected off the optical separating units to the light receiving elements respectively.

7. The distance measuring apparatus according to claim 4, wherein
the light receiving elements are disposed on an identical plane and face along the same direction as each other,
positional relationships of the first deflection members with respect to the corresponding light receiving elements are the same as each other, and
attitudes of the first deflection members with respect to the corresponding light receiving elements are the same as each other.

8. The distance measuring apparatus according to claim 4, wherein the first deflection members are disposed outside the base member.

9. The distance measuring apparatus according to claim 1, wherein on a downstream side of the rays of outgoing light from the optical separating units, optical paths of the rays of outgoing light and corresponding optical paths of the rays of return light are coaxial.

10. The distance measuring apparatus according to claim 1 further comprising second deflection members to direct the rays of outgoing light, which travel via the optical separating units, to the optical scanning unit and direct the rays of return light reflected off the optical scanning unit to the optical separating units respectively.

11. The distance measuring apparatus according to claim 10, wherein the second deflection members deflect the rays of outgoing light, which travel toward the second deflection members and are parallel to each other, so that the deflected rays of outgoing light are incident on the optical scanning unit at different angles of incidence from each other.

12. The distance measuring apparatus according to claim 10, wherein optical paths of the rays of return light from the second deflection members to the light receiving elements are parallel to each other.

13. The distance measuring apparatus according to claim 1, wherein the number of the light receiving elements is three or more.

14. The distance measuring apparatus according to claim 1 further comprising optical filters to transmit light having a predetermined wavelength band on optical paths of the rays of return light toward the light receiving elements and to attenuate light having wavelength band other than the predetermined wavelength band.

15. The distance measuring apparatus according to claim 1 further comprising aperture units disposed on optical paths of the rays of return light toward the light receiving elements respectively.

16. The distance measuring apparatus according to claim 1 further comprising light receiving-and-condensing members to condense the rays of return light respectively.

17. The distance measuring apparatus according to claim 16, wherein the light receiving-and-condensing members condense the rays of outgoing light respectively.

18. The distance measuring apparatus according to claim 1, wherein a direction in which the rays of return light, which are just before incident on the light receiving elements, travel and a direction in which the rays of outgoing light, which are just after emitted from the light emitting units, travel are parallel to each other.

19. The distance measuring apparatus according to claim 6, wherein
the light receiving elements are disposed on an identical plane and face along the same direction as each other,
positional relationships of the first deflection members with respect to the corresponding light receiving elements are the same as each other, and
attitudes of the first deflection members with respect to the corresponding light receiving elements are the same as each other.

20. The distance measuring apparatus according to claim 6, wherein the first deflection members are disposed outside the base member.

21. The distance measuring apparatus according to claim 7, wherein the first deflection members are disposed outside the base member.
